(19) United States
(12) Patent Application Publication
(10) Pub. No.: US 2013/0270331 A1
(43) Pub. Date: Oct. 17, 2013

(54) FLEXOGRAPHIC PRINTING, DEVICE AND METHOD

(71) Applicant: Gustavo Barros, Modena (IT)

(72) Inventor: Gustavo Barros, Modena (IT)

(21) Appl. No.: 13/997,561

(22) PCT Filed: Dec. 1, 2011
(86) PCT No.: PCT/EP11/71540

§ 371 Date: Jun. 24, 2013

(30) Foreign Application Priority Data
Dec. 23, 2010 (SE) 1001220-1

(51) Int. Cl. B41F 5/24; B65D 25/00; B42D 15/00

(52) U.S. Cl. CPC B41F 5/24; B42D 15/00; B65D 25/00
USPC 229/116.1; 101/153; 101/170; 283/62

(57) ABSTRACT

A device (40) for flexographic printing, comprising at least a first printing unit (41a) comprising ink with a color for application on a substrate (16) by a first plurality of raised parts (12a) on a first printing forme (11a) and a second printing unit (41b) comprising ink with the color for application on the substrate (16) by a second plurality of raised parts (12b) on second printing forme (11b), wherein the ink (13b) applied by the second printing unit (41b) has a different shade then the ink (13a) applied by the first printing unit (41a).

### TECHNICAL FIELD

This invention pertains in general to the field of flexographic printing. More particularly, the invention relates to a method for expanding the dynamic range of a print and producing a broader spectrum of color appearance to the printed image.

### BACKGROUND

Flexographic printing is a well known and widely used printing process. It can be used for printing on a diversity of substrates, including paper, cellophane, metallic films and plastic, and it is widely used for e.g. printing on substrates required for various type of food packaging. Flexography is especially important for printing liquid carton packaging laminates, due to cost efficiency and good results. A flexographic print is made by creating a mirrored master of the required image where the image areas are raised above the non-image areas on a printing forme, such as a photopolymer plate or a roller. In a typical aspect of this printing method, printing formes are used to create large scale printed products, such as milk and beverage cartons, disposable cups and containers, folding cartons, boxes, envelopes and wallpaper. This can be achieved by processing the substrate to be printed subsequently through different printing units, each printing unit containing and adding one specific color of ink, onto the substrate surface. Typically, a number of colors are combined according to a subtractive or additive color model, to generate an image in a way well known to a person skilled in the art. A common application utilizes four printing units, i.e. four process colors CMYK, to produce an image.

Typically, printing according to prior art comprises using a first printing unit such as described above, to print ink with a first color such as cyan onto the substrate. Analogously, a second, third and fourth printing step using a second, third and fourth printing unit such as described above to print ink with a second, third and fourth color, such as magenta, yellow and black (key), respectively, onto the substrate. The resulting image comprises a wide variety of colors generated by the relative mix of the abovementioned four colors. The choice of colors, their number and their relative printing sequence may differ from the above mentioned example.

Besides mixing colors according to above, use of so called halftones may be used to create reprographic effects. This is obtained by using marks, such as dots, with varying size or spacing or a combination of both. A halftone print thus gives the visual appearance of a darker color where the marks are larger, and a gradual fading of the color to a lighter appearance where the marks are smaller.

An inherent limitation with the flexographic printing process is the fact that the raised parts have to have a certain critical size, in order to be able to effectively transfer the ink from the print forme surface to the substrate.

This makes it hard to accurately produce bright shades of colors on the substrate when using halftoning, due to the limitations in producing and using raised parts with small size; these cannot be manufactured to have a small enough size for printing of the brightest color appearances.

Hence, an improved method for flexographic printing would be advantageous and in particular a method allowing for increased flexibility, with expanded dynamic range, wider color spectrum and/or cost-effectiveness.

### SUMMARY

Accordingly, the present invention preferably seeks to mitigate, alleviate or eliminate one or more of the above-identified deficiencies in the art and disadvantages singly or in any combination and solves at least the above mentioned problems by providing a device, a method and a printed substrate according to the appended claims.

According to an aspect, a device for flexographic printing is provided, comprising at least a first printing unit comprising ink with a color for application on a substrate by a first plurality of raised parts on a first printing forme and a second printing unit comprising ink with the color for application on the substrate by a second plurality of raised parts on second printing forme, wherein the ink applied by the second printing unit has a different shade than the ink applied by the first printing unit, but the same color, or a similar color which is perceived as the same color.

According to another aspect, a method for flexographic printing of a substrate is provided. Said method comprises the steps of applying ink with a first shade of a color on a substrate by a first set of raised parts of a first printing forme on a first printing unit; and applying ink with a second shade of the color on the substrate by a second set of raised parts of a second printing forme on a second printing unit, to obtain a printed substrate.

According to yet another aspect, a printed substrate is provided, said printed substrate being obtainable by the method according to an aspect.

Further embodiments and advantages of which the invention is capable are disclosed in the description and in the claims.

The present invention has the advantage over the prior art that it provides increased flexibility, expanded dynamic range, wider color spectrum and/or cost-effectiveness.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIG. 1 is an illustration of a device according to an embodiment;

FIG. 2 is an illustration of a device according to another embodiment;

FIG. 3 is an illustration of a halftone print according to an embodiment;

FIG. 4 is a schematic illustration of a method according to an embodiment; and

FIG. 5 is a schematic illustration of a method according to another embodiment.

### DETAILED DESCRIPTION

Several embodiments of the present invention will be described in more detail below with reference to the accompanying drawings in order for those skilled in the art to be able to carry out the invention. The invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments do not limit the invention, but the invention is only limited by the appended patent claims. Furthermore, the terminology used in the detailed description of the particular embodiments illustrated in the accompanying drawings is not intended to be limiting of the invention.

The following description focuses on an embodiment of the present invention applicable to flexographic printing and in particular to flexographic color printing using two-roll inking. However, as will be appreciated by a person skilled in the art, the invention may be embodied in any kind of flexographic printing, such as chambered doctor-blade etc.

In an embodiment according to FIG. 1 a device 40 for flexographic printing is disclosed. The device 40 comprises a first printing unit 41a comprising ink with a color for application on a substrate 16 by a first plurality of raised parts 12a on a first printing forme 11a, such as a printing plate and a second printing unit 41b comprising ink with the color for application on a substrate 16 by a second plurality of raised parts 12b on a second printing forme 11b, such as a printing plate, wherein the ink 13b applied by the second printing unit 41b has a different shade than the ink 13a applied by the first printing unit 41a, but the same color, or a similar color which is perceived as the same color. A lighter shade of a color has the same or similar perceived hue, as a dark shade of the color, but with a lower chroma.

Any kind of printing unit may be used within the scope of the invention, as will be appreciated by a person skilled in the art. For example, a printing unit described above with reference to FIG. 1 may be used.

In use, the printing unit may apply ink 13 on a fountain roll 14 and distribute it evenly by an anilox roll 15 before transferring it to the raised parts 12 on a printing forme 11, mounted on a printing cylinder 10. Said raised parts 12 are disposed to be in contact with a substrate 16, each raised part leaving an ink mark 17, such as a dot, on the printed substrate. The combined marks 17 from all raised parts 12 of all the printing units used, creates the total image on the substrate 16.

By combining a first 41a and a second 41b printing unit according to above, both applying ink with the same or similar color, but with different shades “a” and “b”, it is possible to benefit from the advantage that an expanded dynamic range and a wider color spectrum of the finished print is possible, since the visual appearance of the color is not only depending on the size, position and shape of the raised parts 12a, 12b, but also the combination of color shades 13a and 13b.

With prior art flexographic printing systems, a part of the total spectrum in the lighter part (from black to white) is impossible to recreate, since the raised parts cannot distribute the ink to the substrate below a certain critical size. That part will be perceived as white. With some types of flexographic printing, this may be as much as 20% of the total spectrum. Thus, a further advantage with the invention is that a light, or bright, visual appearance of a color is possible to recreate, since a lighter shade of the color, created with large marks of a lighter shade may prolong the visual spectrum of the color where the marks of the darker shade of the color are too small to be reproduced by the raised parts 12.

In an embodiment, the ink 13b applied by the second printing unit 41b has a lighter shade than the ink 13a applied by the first printing unit 41a, but the same color, or a similar color which is perceived as the same color. As will be appreciated by a person skilled in the art, the ink 13a and the ink with lighter shade 13b are designed to be compatible in different aspects, such as transparency, lay down, trapping etc. An advantage with this is that the different shades can be superimposed.

The ink with lighter shade 13b may or may not block the ink 13a depending on their relative transparency properties.

Printed marks may be in relative register but not necessarily or exclusively on top on each other in such an arrangement as to create the visual appearance of a continuum when printing a gradient.

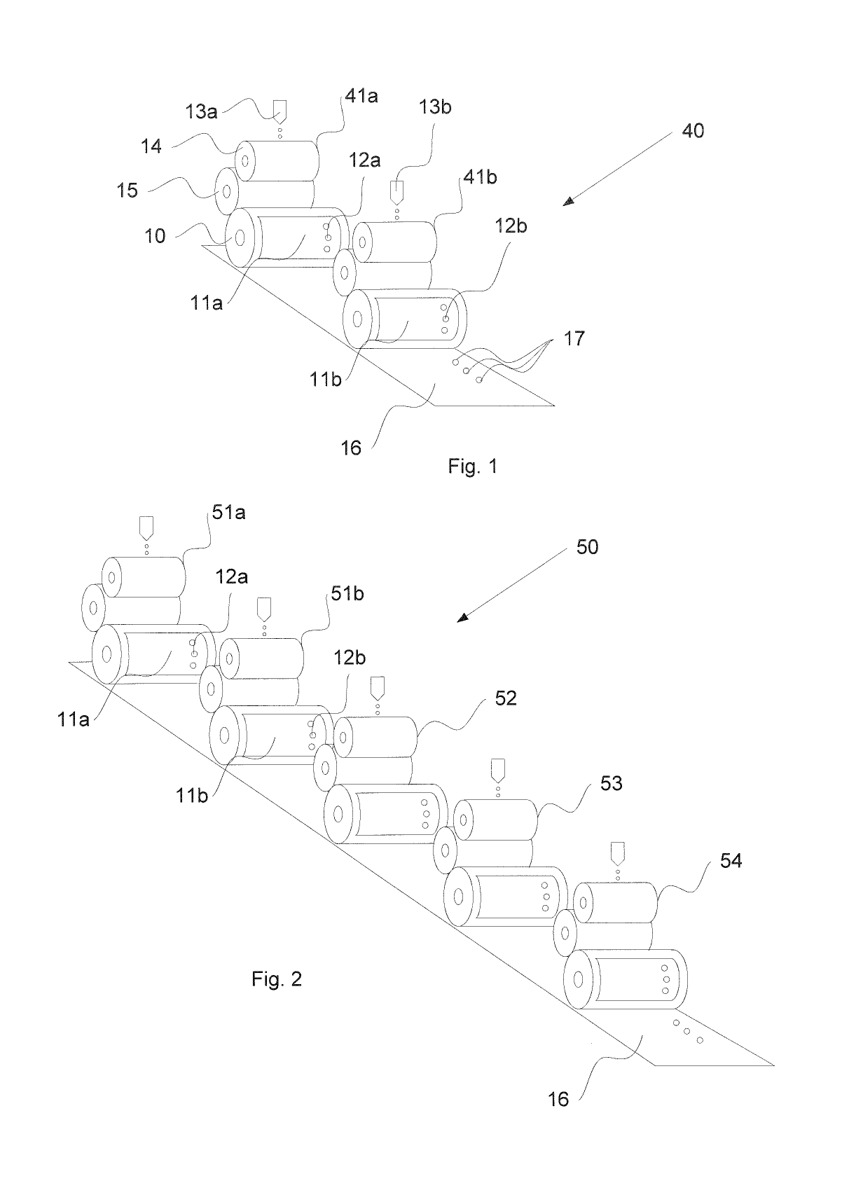

In an embodiment according to FIG. 2, applicable to a subtractive or additive color model, such as process printing using CMYK, five printing units 51a, 51b, 52, 53, 54 according to prior art, such as provided in relation to FIG. 1, are used for applying ink to a printing substrate 16. Each printing unit 51a, 51b, 52, 53, 54 applies ink to the printing forme. A first printing unit 51a applies ink with color cyan with the first plurality of raised parts 12a. A second printing unit 51b applies ink with color cyan with the second plurality of raised parts 12b, where the ink has a lighter shade than the ink applied by the first printing unit 51a. A third 52, fourth 53 and fifth 54 printing unit applies ink with colors magenta, yellow and black, respectively.

Thus, the first 51a and second 51b printing unit applies ink with the same or similar color, i.e. cyan, but with different shades. The order in which the ink is applied (light/dark or dark/light) may or may not be relevant depending on the specific situation. The abovementioned advantages related to this thus also applies to multiple color images. The additional colors are superimposed on the substrate to provide the final printed image.

As will be appreciated by a person skilled in the art, any number of the different printing units, such as in this case also magenta, yellow or key (black) may be duplicated to apply ink with two or more shades.

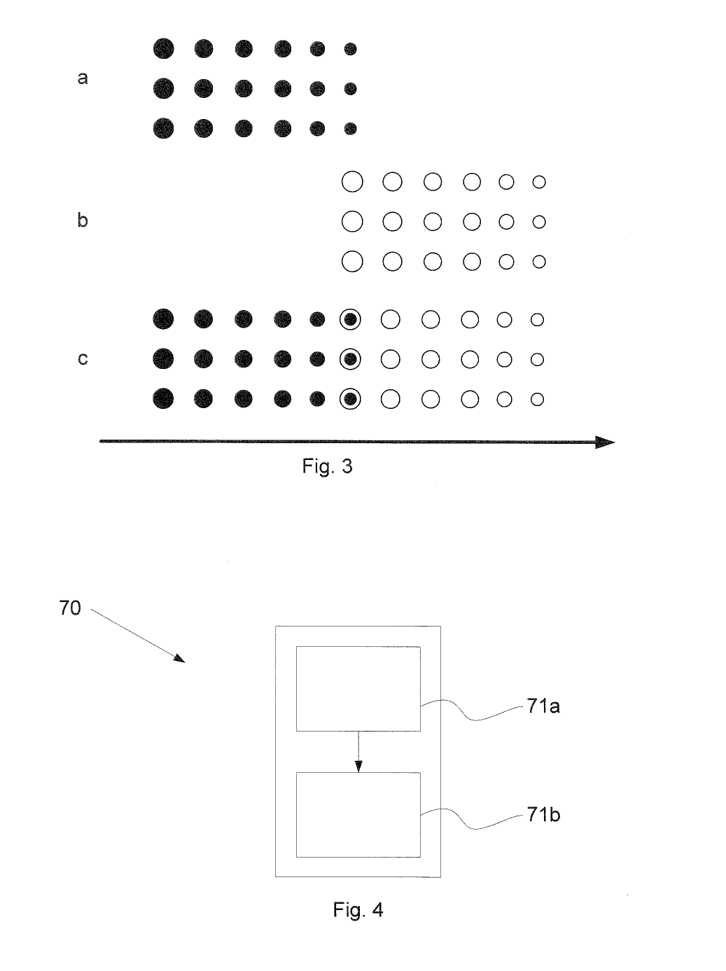

FIG. 3 is a close up illustration of a halftone print consisting of a color “a” and a lighter shade of the same or similar color “b”. The print gives the visual effect of a darker gradient of the color on the left side of the arrow and gradual fading of the color to a lighter appearance on the right side of the arrow. The visual effect of gradual fading of the color is partly due to the halftone effect where larger marks leads to a darker visual appearance and smaller marks leads to a lighter visual appearance, but also due to the fact that a darker “a” and lighter “b” shade of the color are combined to form the print. An example of the resulting combination of “a” and “b” are shown in “c”, where the color “a” has been superimposed on the lighter shade of the same or similar color “b”.

Thus, a method for halftoning is provided. Said method comprises the steps of separating the information to be printed using an ink with a shade of a color by means of raised parts, into at least two separate sets of raised parts 12a, 12b. Each set of raised parts 12a, 12b utilize ink with the same or similar color, but with different respective shades, to obtain a printed substrate. Halftoning may thus occur before, after or during the color separation procedure.

A further advantage with this is that a light, or bright, visual appearance of a color including a gradient is possible to recreate, since a lighter appearance of the color, created with large marks of a lighter shade may prolong the visual spectrum where the marks of the darker shade of the color are too small to be correctly reproduced by the raised parts 12.

In an embodiment, the first plurality of raised parts 12a or the second plurality of raised parts 12b of the device 40, 50 forms patterns giving halftone prints on the substrate 16.

Hence, it is possible to create prints with an overlap in the color of different shades applied onto the printed substrate 16 by the first and second set of raised parts 12a, 12b, i.e. the colored marks produced by printing units 41a, 51a and 41b, 51b, but there will also be a shift in visual color appearance towards a lighter, or brighter, appearance, created by the raised parts in printing unit 41b, 51b, as compared to by printing unit 41a, 51a.

In an embodiment, the first plurality of raised parts 12a and the second plurality of raised parts 12b of the device 40, 50 combine to form patterns giving halftone prints on the substrate 16. The first and second plurality of raised parts 12a, 12b are configured on the first and second printing forme 11a, 11b, respectively, so that the halftone prints are positioned in relation to each other, such as superimposed on the substrate 16 so that larger dots from the second plurality of raised parts 12b coincide with smaller dots from the first plurality of raised parts 12a to create a continuous halftone effect.

As will be appreciated by a person skilled in the art, the first and second plurality of raised parts 12a, 12b may be combined in a wide variety of ways, as long as they create a visual appearance of continuous gradient/tone effect. Examples of such combinations are superimposed, side-by-side, etc. The desired effect may also be obtained by using inks with different transparency properties, combination of different raster patterns, combination of different raster technologies or a combination of several of these and other options.

In an embodiment according to FIG. 4, a method 70 for flexographic printing is provided. Said method 70 comprises a first step of applying 71a ink with a first shade of a color on a substrate by a first set of raised parts 12a on a first printing forme 11a and a second step of applying 71b ink by a second set of raised parts 12b on a second printing forme 11b with a second shade of the color on a substrate, to obtain a printed substrate 16.

An advantage with this is increased flexibility and improved quality of the resulting print, since the regulation of the print may be based both on color aspects related to the two shades “a” and “b” and mechanical printing aspects related to the raised parts 12a, 12b.

Yet another advantage is cost-effectiveness, since the method allows flexographic printing of images which previously were only printable by more expensive printing methods.

The abovementioned method may be applied with a subtractive or additive color model, such as CMYK.

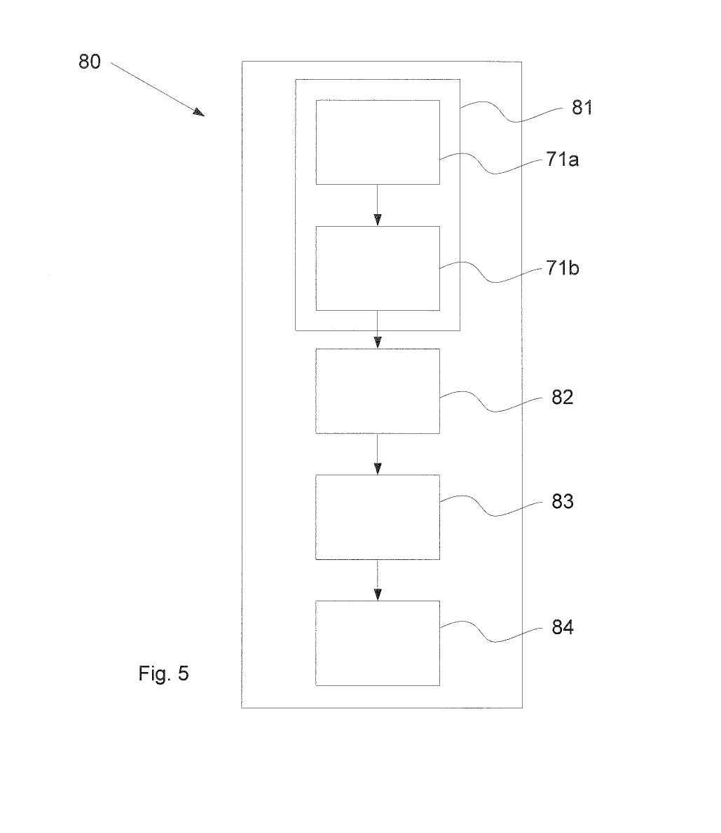

In an embodiment according to FIG. 5, a method 80 for flexographic color printing of a substrate 16 is provided. Said method 80 comprises a step of applying ink with cyan color 81. The application of ink with cyan color 81 is done in a first step of applying 71a ink with a first shade of cyan color on a substrate by a first set of raised parts 12a on a first printing forme 11a and a second step of applying 71b ink by a second set of raised parts 12b on a second printing forme 11b with a second shade of the cyan color on a substrate. The method further comprises a step of applying ink with magenta color 82, a step of applying ink with yellow color 83 and a step of applying ink with black (key) color 84. The subsequent application steps 82, 83, 84 may all be done with printing units comprising printing formes 11 with raised parts 12. The abovementioned advantages related to this thus also applies to multiple color images. The additional colors are superimposed on the substrate to provide the final printed image.

As will be appreciated by a person skilled in the art, any number of the different printing units, such as in this case also magenta, yellow or key (black) may be duplicated to apply ink with two shades.

In an embodiment, the method 70, 80 further comprises the step of configuring both the first plurality of raised parts 12a and the second plurality of raised parts 12b on the first and second printing forme 11a, 11b, respectively, so that the halftone prints are superimposed on the substrate 16 so that dots from the second plurality of raised parts 12b coincide with dots from the first plurality of raised parts 12a to create a continuous halftone effect.

In an embodiment, the substrate 16 in the method 70, 80 according to some embodiments is a paper, a paperboard or a packaging laminate.

An advantage with this is a wider color spectrum and an expanded dynamic range of the resulting print due to the factors mentioned above with reference to FIG. 3.

In an embodiment, a printed substrate 16 is provided, said printed substrate 16 being obtainable by the method 70, 80 as described above.

In an embodiment, the printed substrate 16 is a paper, a paperboard or a packaging laminate.

In an embodiment, a paper or board packaging container is provided, wherein said paper or board packaging container is made from the printed substrate 16 some embodiments, according to methods well known to a person skilled in the art.

Although the present invention has been described above with reference to specific embodiments, it is not intended to be limited to the specific form set forth herein. Rather, the invention is limited only by the accompanying claims and, other embodiments than the specific above are equally possible within the scope of these appended claims.

In the claims, the term “comprises/comprising” does not exclude the presence of other elements or steps. Furthermore, although individually listed, a plurality of means, elements or method steps may be implemented by e.g. a single unit. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A device for flexographic printing, comprising:
a first printing unit configured to apply ink of a first color on a substrate by a first plurality of raised parts on a first printing forme; and
a second printing unit configured to apply ink of a second color on the substrate by a second plurality of raised parts on a second printing forme,
wherein the ink applied by the second printing unit has a different shade than the ink applied by the first printing unit, and wherein the first plurality of raised parts and the second plurality of raised parts form patterns giving halftone prints on the substrate, and
wherein the first and second plurality of raised parts are configured on the first and second printing formes, respectively, so that the halftone prints are combined on the substrate such that marks from the second plurality of raised parts are combined with marks from the first plurality of raised parts.

2. The device according to claim 1, wherein the ink applied by the second printing unit has a lighter shade than the ink applied by the first printing unit.

3. The device according to claim 1, wherein the ink applied by the second printing unit has a darker shade than the ink applied by the first printing unit.

4. (canceled)

5. (canceled)

6. The device according to claim 1, comprising at least one printing unit for each color in a subtractive or additive color model.

7. The device according to claim 6, wherein the subtractive or additive color model is CMYK.

8. A flexographic printing method for printing of a substrate, comprising:
applying ink with a first shade of a color on a substrate by a first set of raised parts of a first printing forme on a first printing unit;
applying ink with a second shade of the color on the substrate by a second set of raised parts of a second printing forme on a second printing unit, to obtain a printed substrate, wherein the first plurality of raised parts and the second plurality of raised parts form patterns giving halftone prints on the substrate; and
configuring both the first plurality of raised parts and the second plurality of raised parts on the first and second printing formes, respectively, so that the halftone prints are combined on the substrate such that marks from the second plurality of raised parts combine with marks from the first plurality of raised parts.

9. The method according to claim 8, wherein the color is chosen from the group consisting of cyan, magenta, yellow and black.

10. The method according to claim 9, further comprising the additional steps of applying the other colors from the group consisting of cyan, magenta, yellow and black to obtain a printed substrate.

11. (canceled)

12. The method according to claim 8, wherein the substrate is a paper, a paperboard or a packaging laminate.

13. A printed substrate obtained by the method according to claim 8.

14. The printed substrate according to claim 13, wherein the printed substrate is a paper, a paperboard or a packaging laminate.

15. A paper or board packaging container, obtained by the method according to claim 8, and wherein the printed substrate is a paper, a paperboard or a packaging laminate.

16. The method according to claim 8, wherein combining the halftone prints on the substrate creates a visual appearance of a continuous halftone effect.

17. The method according to claim 8, wherein the ink applied by the second printing unit has a darker or lighter shade than the ink applied by the first printing unit.

18. The method according to claim 17, wherein the ink applied by the second printing unit has a lighter shade than the ink applied by the first printing unit.
